(19) United States
(12) Patent Application Publication
(10) Pub. No.: US 2026/0281263 A1
(43) Pub. Date: Sep. 17, 2026

(54) INFORMATION PROCESSING SYSTEM, NON-TRANSITORY COMPUTER READABLE MEDIUM, AND INFORMATION PROCESSING METHOD

(71) Applicant: FUJIFIM Business Innovation Corp., Tokyo (JP)

(72) Inventor: Yuji OHASHI, Kanagawa (JP)

(73) Assignee: FUJIFIM Business Innovation Corp., Tokyo (JP)

(21) Appl. No.: 19/307,971

(22) Filed: Aug. 22, 2025

(30) Foreign Application Priority Data
Mar. 17, 2025 (JP) 2025-042610

(51) Int. Cl. H04N 1/00; H04N 1/44

(52) U.S. Cl. CPC H04N 1/00514; H04N 1/0048; H04N 1/4413

(57) ABSTRACT

An information processing system includes: a processor configured to: set an approval rule that, for a setting item having multiple available setting values and being related to a setting target device, defines a setting value settable by a set up person without obtaining approval from an approver, a setting value settable by the set up person on a condition of obtaining approval from the approver, and a setting value impossible to be set by the set up person according to direction from the approver; and upon direction given by the set up person to change a setting value for the setting item, perform a setting process for the setting value for the setting item according to the approval rule.

### CROSS-REFERENCE TO RELATED APPLICATIONS

This application is based on and claims priority under 35 USC 119 from Japanese Patent Application No. 2025-042610 filed March 17, 2025.

### BACKGROUND

### Technical Field

The present disclosure relates to an information processing system, a non-transitory computer readable medium, and an information processing method.

### Related Art

In order to change the setting for a setting target device in related art, specifically, in order to change the setting value for a setting item by a set up person, approval of an approver may be necessary.

For example, Japanese Unexamined Patent Application Publication No. 2017-107412 discloses a printer as a setting target device that, when accepting direction to change the setting related to the printer from a user (set up person) of the printer, transmits an E-mail including access information to a web page for approving change of the setting to the administrator (approver) of the printer, and upon approval of the change of the setting by the administrator, executes the change of the setting.

### SUMMARY

However, in a setting target device that needs approval of an approver to change the setting value for a setting item by a set up person, at least one of the set up person or the approver takes time and effort for required approval of the approver for each change of the setting value. For example, a set up person may be unable to change the setting value and needs to wait until approval from the approver is obtained, and an approver is required to approve each change of the setting value, thus an approval process can be extremely complicated.

Aspects of non-limiting embodiments of the present disclosure relate to an information processing system that, in a setting target device that needs approval of an approver to change the setting value for a setting item by a set up person, reduces the time and effort of at least one of the set up person or the approver when the setting value is changed, as compared to when approval of the approver is required each time direction to change the setting value is received.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: a processor configured to: set an approval rule that, for a setting item having a plurality of available setting values and being related to a setting target device, defines a setting value settable by a set up person without obtaining approval from an approver, a setting value settable by the set up person on a condition of obtaining approval from the approver, and a setting value impossible to be set by the set up person according to direction from the approver; and upon direction given by the set up person to change a setting value for the setting item, perform a setting process for the setting value for the setting item according to the approval rule.

### BRIEF DESCRIPTION OF THE DRAWINGS

Exemplary embodiment of the present disclosure will be described in detail based on the following figures, wherein:

FIG. 1 is a schematic configuration diagram of an approval rule setting system according to the exemplary embodiment;

FIG. 2 is a schematic configuration diagram of an approver terminal;

FIG. 3 is a schematic configuration diagram of a multifunction machine;

FIG. 4 is a first flowchart illustrating the flow of a process of the approval rule setting system;

FIG. 5 is a second flowchart illustrating the flow of the process of the approval rule setting system;

FIG. 6 is a view illustrating an example of an approval screen;

FIG. 7 is a view illustrating an example of an approval unnecessary confirmation window;

FIG. 8 is a view illustrating an example of a setting prohibition confirmation window;

FIG. 9 is a view illustrating an example of a setting value change window;

FIG. 10 is a view illustrating an example of a first approval rule setting window;

FIG. 11 is a view illustrating an example of a second approval rule setting window;

FIG. 12 is a view illustrating an example of a third approval rule setting window;

FIG. 13 is a view illustrating an example of a fourth approval rule setting window;

FIG. 14 is a view illustrating an example of a fifth approval rule setting window;

FIG. 15 is a view illustrating an example of a sixth approval rule setting window; and

FIG. 16 is a flowchart illustrating the flow of a setting process for a common approval rule.

### DETAILED DESCRIPTION

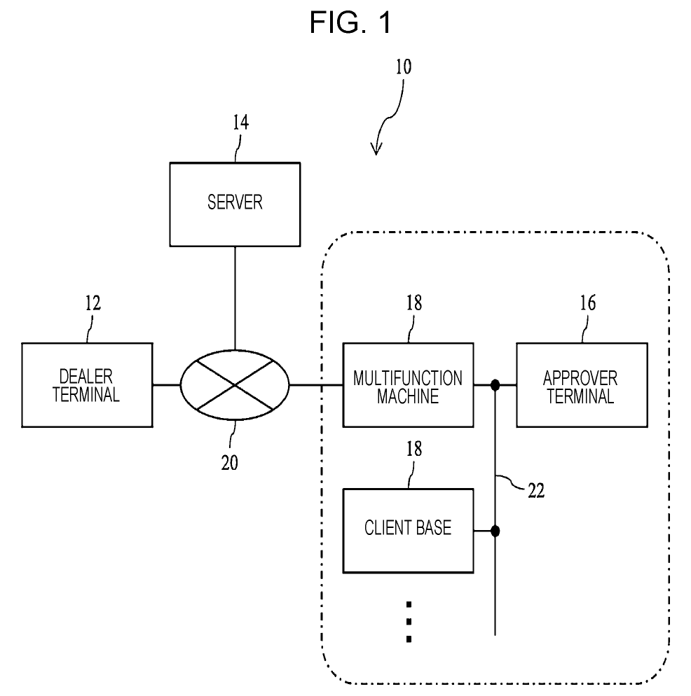

FIG. 1 is a schematic configuration diagram of an approval rule setting system 10 according to the exemplary embodiment. The approval rule setting system 10 includes a dealer terminal 12, a server 14, an approver terminal 16, and one or a plurality of multifunction machines 18 as setting target devices. In the exemplary embodiment, the approver terminal 16 and the multifunction machines 18 are installed in a client base, and the dealer terminal 12 and the server 14 are installed in locations remote from the client base. In the exemplary embodiment, it is assumed that the client is A company, and the approver terminal 16 and the multifunction machines 18 are installed in the building of the A company, as the client base. The dealer terminal 12, the server 14, and the multifunction machines 18 are communicably connected to each other through a communication line 20 including a local area network (LAN) and a wide area network (WAN), and the approver terminal 16 and the multifunction machines 18 are communicably connected to each other through a LAN 22.

The dealer terminal 12 is comprised of e.g., a personal computer, a tablet terminal or the like. The dealer terminal 12 includes a processor such as a central processing unit (CPU); a memory such as a hard disk drive (HDD), an embedded multimedia card (eMMC), a read only memory (ROM), or a random access memory (RAM); a communication interface such as a network adapter; an input interface such as a keyboard or a mouse; and a display such as a liquid crystal display.

The dealer terminal 12 is to be used by a dealer who has sold the multifunction machines 18 to the client. In the exemplary embodiment, the dealer is not an employee of the A company, and different from the users of the multifunction machines 18 and the later-mentioned approver.

The server 14 is comprised of e.g., a server computer or the like. The server 14 includes a processor such as a CPU; a memory such as an HDD, an eMMC, a ROM or a RAM; and a communication interface such as a network adapter.

The server 14 provides the dealer with the service for managing the setting target devices. In the exemplary embodiment, the setting target devices are multifunction machines 18, thus the server 14 provides the service for managing the multifunction machines 18. Such a service is also called managed print service (MPS). Specifically, the MPS is the service for remotely managing the consumables and the use status of each multifunction machine 18, and in addition, making various settings of the multifunction machine 18. The service such as the MPS allows a dealer to remotely perform not only the sale of a multifunction machine 18, but also the maintenance service of each multifunction machine 18.

In the approval rule setting system 10, the dealer utilizes the MPS to remotely change the setting of the multifunction machine 18 installed in the client base (in the building of the A company in the exemplary embodiment). In other words, in the exemplary embodiment, the dealer is a set up person who makes the setting of the multifunction machine 18 which is a setting target device, and the dealer terminal 12 is a set up person terminal used by a set up person. The setting of the multifunction machine 18 consists of various setting items and setting values for the items.

Among the employees of the A company which is a client, an administrator (which is synonymous with an "approver" in the present specification, and hereinafter referred to as an approver) who manages the multifunction machine 18 is elected, and approval from the approver is needed to change the setting of the multifunction machine 18. As described in detail below, in the approval rule setting system 10, the dealer or the approver is supported to reduce the time and effort of at least one of them when the setting of the multifunction machine 18 is changed.

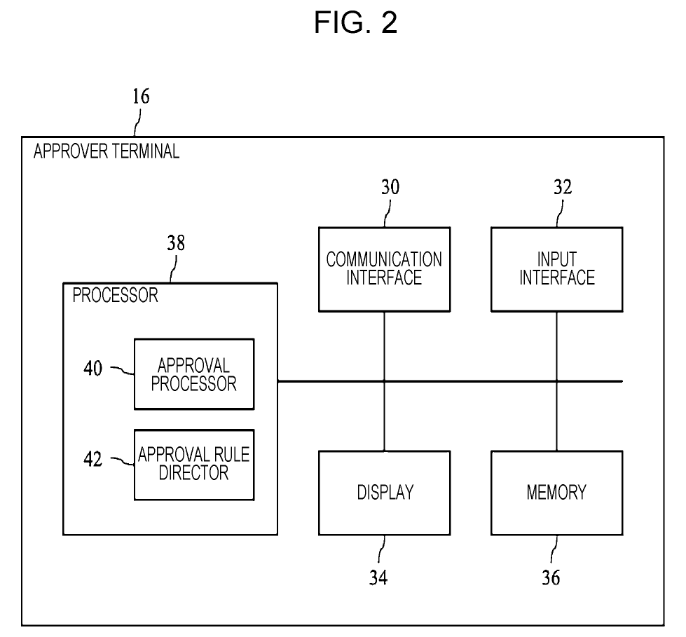

FIG. 2 is a schematic configuration diagram of an approver terminal 16. The approver terminal 16 is a device to be used by an approver, and comprised of e.g., a personal computer, a tablet terminal or the like.

The communication interface 30 is comprised of e.g., a network adapter or the like. The communication interface 30 fulfills the function of communicating with the multifunction machine 18 through the LAN 22.

An input interface 32 is comprised of e.g., a keyboard, a mouse, a button, a touch panel and the like. The input interface 32 is used when an approver inputs direction to the approver terminal 16.

A display 34 is comprised of e.g., a liquid crystal display or the like. Various screens are displayed on the display 34 according to the direction from the later-described processor 38.

A memory 36 is comprised of an HDD, an eMMC, a ROM, a RAM or the like. The memory 36 stores an approver terminal program for causing the components of the approver terminal 16 to operate. Note that the approver terminal program may be stored in e.g., a non-transitory computer readable recording medium such as a universal serial bus (USB) memory or an SD card. The approver terminal 16 can read the approver terminal program from such a recording medium and execute it.

The processor 38 is comprised of e.g., a CPU or the like. The processor 38 is communicably connected to the communication interface 30, the input interface 32, the display 34, and the memory 36 through a data bus. The processor 38 performs control of each component of the approver terminal 16 by the approver terminal program stored in the memory 36. In addition, the processor 38 fulfills the functions as an approval processor 40 and an approval rule director 42 by the approver terminal program.

When the dealer as a set up person tries to change the setting of the multifunction machine 18, in other words, when direction to change the setting of the multifunction machine 18 is received from the dealer terminal 12, the approval processor 40 accepts an approval request for change of the setting from the multifunction machine 18. The approval request includes a setting item specified by the dealer and a setting value for the setting item. In the present specification, the setting specified by the dealer is called the changed setting, and the setting value for the changed setting is called the changed setting value. The approval processor 40 approves whether the setting should be changed according to the direction of the approver based on the approval request. A result of approval by the approval processor 40 is transmitted to the multifunction machine 18, and when the request is approved, the changed setting is applied to the multifunction machine 18, and when the request is not approved, the changed setting is not applied to the multifunction machine 18.

The approval rule director 42 directs the multifunction machine 18 to apply an approval rule according to the direction from the approver, the approval rule being related to approval for change of the setting of the multifunction machine 18. Although a detailed description is given below, the approval rule defines whether, when the dealer tries to change the setting of the multifunction machine 18, change of the setting is possible without obtaining approval from the approver, change of the setting is possible on the condition of obtaining approval from the approver, or change of the setting is impossible regardless of approval of the approver.

The details of the process of the approval processor 40 and the approval rule director 42 will be described later.

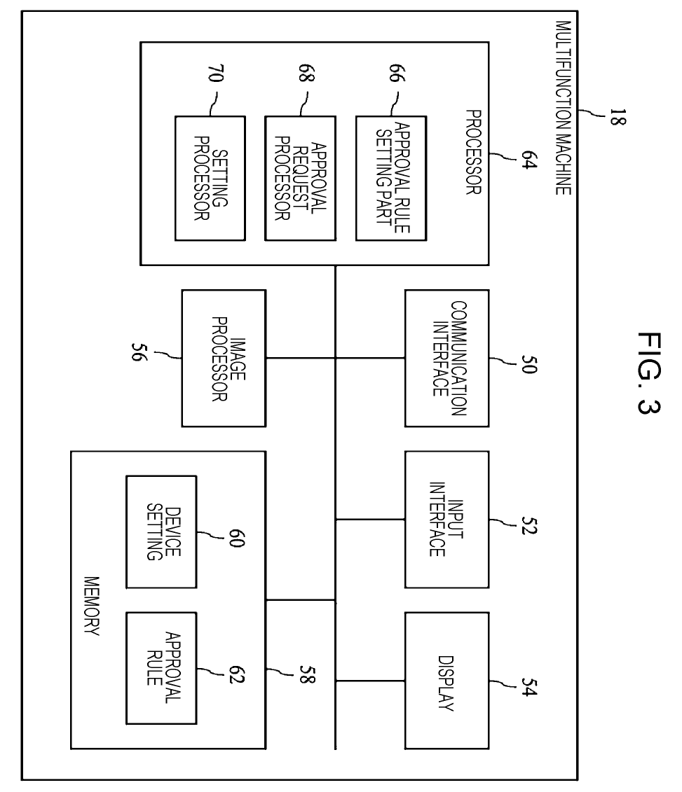

FIG. 3 is a schematic configuration diagram of a multifunction machine 18. The multifunction machine 18 is an office automation (OA) device that fulfills a plurality of functions such as a print function, a copy function, a scan function, and a FAX function.

The communication interface 50 is comprised of e.g., a network adapter. The communication interface 50 fulfills the function of communicating with the dealer terminal 12 and the server 14 through the communication line 20. The communication interface 50 fulfills the function of communicating with the approver terminal 16 through the LAN 22.

The input interface 52 is comprised of e.g., a button, a touch panel or the like. The input interface 52 is used when a user inputs direction to the multifunction machine 18.

The display 54 is comprised of e.g., a liquid crystal panel or the like. Various screens are displayed on the display 54 according to the direction from the later-described processor 64.

The image processor 56 is comprised of e.g., a printer unit, a scanner unit or the like. The image processor 56 executes various image processes such as a print process, a scan process or a copy process according to the direction from the processor 64.

A memory 58 is comprised of an HDD, an eMMC, a ROM, a RAM or the like. The memory 58 stores an information processing program for causing the components of each multifunction machine 18 to operate. Note that the information processing program may be stored in e.g., a non-transitory computer readable recording medium such as a USB memory or an SD card. The multifunction machine 18 can read the information processing program from such a recording medium and execute it. As illustrated in FIG. 3, the memory 58 stores a device setting 60 and an approval rule 62.

The device setting 60 provides the current setting of the multifunction machine 18. As described above, the setting of the multifunction machine 18 consists of various setting items, and setting values for the items, thus the device setting 60 shows the setting values for a plurality of setting items. The plurality of setting items include the ones for which a setting value is selectable from a plurality of predetermined setting values, and the ones for which a numerical value can be set as a setting value. The setting items for which a setting value is selectable from a plurality of predetermined setting values include e.g., "default color mode". For the setting item "default color mode", "black and white" or "color" is selectable as a setting value.

The approval rule 62 is related to approval for change of the setting of the multifunction machine 18 and is set by the later-described approval rule setting part 66 according to direction from the approval rule director 42 of the approver terminal 16. The approval rule 62 in the exemplary embodiment is a rule that, for a setting item having a plurality of available setting values, defines the setting values settable by the dealer who is a set up person without obtaining approval from the approver, the setting values settable by the dealer on the condition of obtaining approval from the approver, and the setting values impossible to be set by the dealer. For example, for the setting item "default color mode", the setting value "black and white" is settable without obtaining approval from the approver, the setting value "full color" is settable by the dealer on the condition of obtaining approval from the approver, and the setting value "five colors" is impossible to be set by the dealer.

The approval rule 62 may be a rule that, for a setting item of the multifunction machine 18, having a numerical value as a setting value, defines the numerical value range settable without obtaining approval from the approver, the numerical value range settable by the dealer on the condition of obtaining approval from the approver, and the numerical value range impossible to be set by the dealer.

In the exemplary embodiment, when the approval rule setting system 10 includes a plurality of multifunction machines 18, the approval rule 62 is different for each multifunction machine 18.

The processor 64 is comprised of e.g., a CPU or the like. The processor 64 is communicably connected to the communication interface 50, the input interface 52, the display 54, the image processor 56, and the memory 58. The processor 64 controls the components of the multifunction machine 18 by the information processing program stored in the memory 58. In particular, the processor 64 fulfills the functions as the approval rule setting part 66, an approval request processor 68, and a setting processor 70.

The approval rule setting part 66 sets the approval rule 62 according to direction from the approver. Specifically, the approval rule setting part 66 sets the approval rule 62 according to direction from the approval rule director 42 of the approver terminal 16. The approval rule setting part 66 may set the approval rule 62 in advance (in other words, before direction to change the setting of the multifunction machine 18 is given by the dealer); however, in the exemplary embodiment, at the timing when direction to change the setting of the multifunction machine 18 is given by the dealer, the approval rule setting part 66 transmits a notification to prompt setting of the approval rule 62 to the approver terminal 16, and sets the approval rule 62 according to direction from the approval rule director 42 of the approver terminal 16. In particular, at the timing when direction to change the setting value for a setting item of the multifunction machine 18 is given by the dealer, the approval rule setting part 66 sets the approval rule 62 for the setting item. In other words, at the timing, the approval rule setting part 66 does not set the approval rule 62 for any setting item other than the setting item.

When direction to change the setting of the multifunction machine 18 is given by the dealer, the approval request processor 68 performs a process of requesting the approver to approve for change of the setting if necessary. Specifically, the approval request processor 68 transmits an approval request to the approver terminal 16. The approval processor 40 of the approver terminal 16 which has received the approval request approves whether the changed setting should be applied according to direction of the approver.

When direction to change the setting value for a setting item of the multifunction machine 18 is given by the dealer, the setting processor 70 performs a setting process of setting (in other words, applying a changed setting value for the setting item) the device setting 60 according to the approval rule 62.

Specifically, when a changed setting value according to the change direction from the dealer is settable without obtaining approval from the approver in the approval rule 62, the setting processor 70 applies the changed setting as it is without obtaining approval from the approver.

When a changed setting value is settable on the condition of obtaining approval from the approver in the approval rule 62, the setting processor 70 applies the changed setting value under the condition that the approval request processor 68 has obtained approval from the approver. When the approval request processor 68 has not obtained approval from the approver, the setting processor 70 does not apply the changed setting value.

When a changed setting value is impossible to be set in the approval rule 62, the setting processor 70 does not apply the changed setting value.

Note that the setting process performed by the setting processor 70 includes not only the process of changing the setting value for a setting item, but also the process of maintaining the setting value (when the changed setting value and the device setting 60 (in other words, the current setting value) are the same).

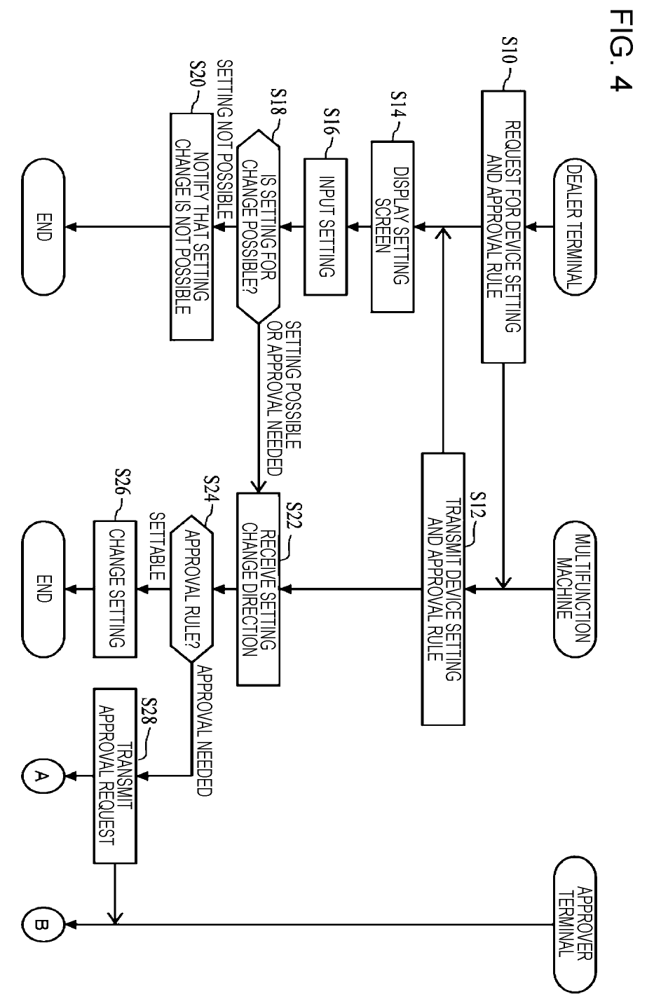

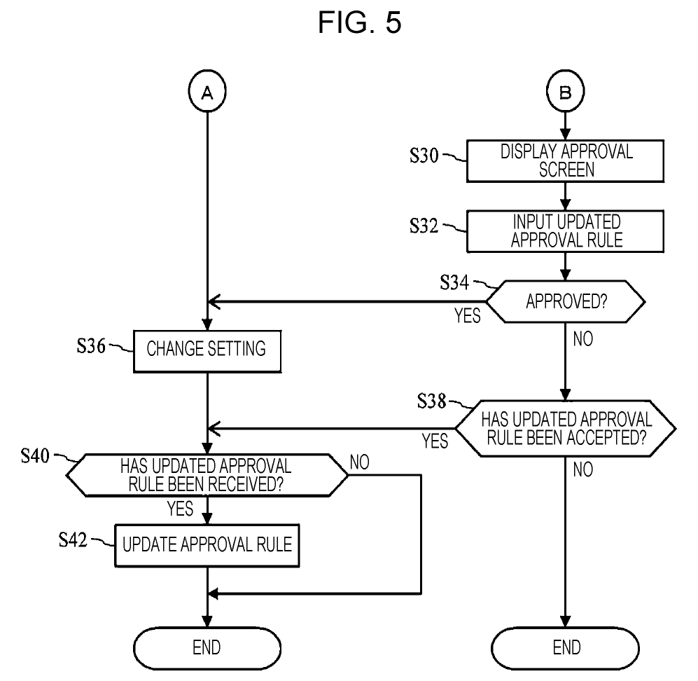

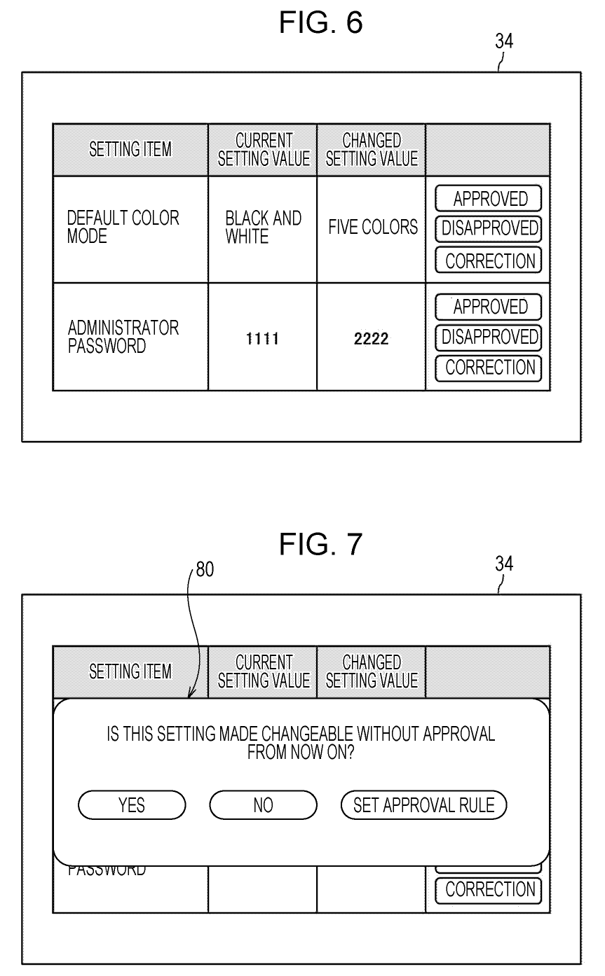

FIGS. 4 and 5 are a flowchart illustrating the flow of the process of the multifunction machine 18. Hereinafter, the details of the process of the approval rule setting system 10 will be described based on the flowchart with reference to FIGS. 6 to 14 as needed.

In step S10, the processor of the dealer terminal 12 requests, according to direction of the dealer, a multifunction machine 18 for the device setting 60 and the approval rule 62 of the multifunction machine 18 whose setting is about to be changed by the dealer.

In step S12, the processor 64 of the multifunction machine 18 transmits the device setting 60 and the approval rule 62 stored in the memory 58 to the dealer terminal 12 according to the request received in step S10.

In step S14, the processor of the dealer terminal 12 displays a setting screen for changing the setting of the multifunction machine 18 on the display of the dealer terminal 12.

In step S16, the dealer inputs the changed setting of the multifunction machine 18 on the displayed setting screen. Specifically, the dealer inputs a setting item for which the setting value is desired to be changed, and a changed setting value (which may be a numerical value) for the setting item. The dealer may input changed setting values for a plurality of setting items.

In step S18, the processor of the dealer terminal 12 refers to the approval rule 62 received in step S12, and determines whether the setting item and the changed setting value input in step S16 are impossible to be set in the approval rule 62. When the setting is determined to be impossible, the flow proceeds to step S20, and in step S20, the processor of the dealer terminal 12 notifies the dealer that the setting input by the dealer in step S16 is impossible to be set in the approval rule 62.

When the setting item and the changed setting value input in step S16 are determined to be settable without obtaining approval from the approver, or settable on the condition of obtaining approval from the approver in the approval rule 62, the processor of the dealer terminal 12 transmits setting change direction including the setting item and the changed setting value input in step S16 to the multifunction machine 18.

In step S22, the multifunction machine 18 receives the setting change direction from the dealer terminal 12.

In step S24, the approval request processor 68 determines whether the setting item and the changed setting value included in the setting change direction received in step S22 are settable without obtaining approval from the approver, or settable on the condition of obtaining approval from the approver in the approval rule 62. When the setting item and the changed setting value are determined to be settable without obtaining approval from the approver, the flow proceeds to step S26, and in step S26, the setting processor 70 changes the device setting 60 based on the setting change direction received in step S22. Specifically, the changed setting value for the setting item included in the setting change direction is applied to the device setting 60.

In step S24, when the setting item and the changed setting value are determined to be settable on the condition of obtaining approval from the approver, the flow proceeds to step S28, and in step S28, the approval request processor 68 transmits an approval request including the setting item and the changed setting value received in step S22 to the approver terminal 16.

In step S30, the approval processor 40 of the approver terminal 16 displays an approval screen for approving change of setting by the dealer on the display 34. FIG. 6 is a view illustrating an example of an approval screen. In the exemplary embodiment, the setting item related to change of setting by the dealer, the current setting value for the setting item, and the changed setting value input by the dealer are shown on the approval screen. The example of FIG. 6 shows that the changed setting value for the setting item "default color mode" with the current setting value of "black and white" is "five colors". In addition, it is shown that the changed setting value for the setting item "administrator password" with the current setting value of "1111" is "2222". For each setting item, an approval button, a disapproval button, and a correction button are displayed on the approval screen, and the approver can select and operate one of these buttons.

In step S32, the approver inputs an approval rule. In order to distinguish from the current approval rule 62 of the multifunction machine 18, the approval rule to be input to the approver terminal 16 by the approver before being set as the approval rule 62 of the multifunction machine 18 is referred to as the "updated approval rule".

When the approver operates the approval button for a certain setting item on the approval screen, the approval processor 40 displays an approval unnecessary confirmation window 80 as illustrated in FIG. 7 on the display 34. The approval unnecessary confirmation window 80 includes a message saying "Is this setting made changeable without approval from now on?", Yes button, No button, and an approval rule setting button.

The Yes button in the approval unnecessary confirmation window 80 is a button for inputting direction to approve the changed setting as well as for inputting direction to change the approval rule 62. When the approver operates the Yes button, the approval processor 40 approves the changed setting value for the setting item, and the approval rule director 42 accepts an updated approval rule that defines the changed setting value for the setting item as the setting value settable without obtaining approval from the approver.

The No button in the approval unnecessary confirmation window 80 is simply a button for inputting direction to approve the changed setting. When the approver operates the No button, the approval processor 40 approves the changed setting value for the setting item. In this situation, the updated approval rule is not input.

The approval rule setting button in the approval unnecessary confirmation window 80 will be described below.

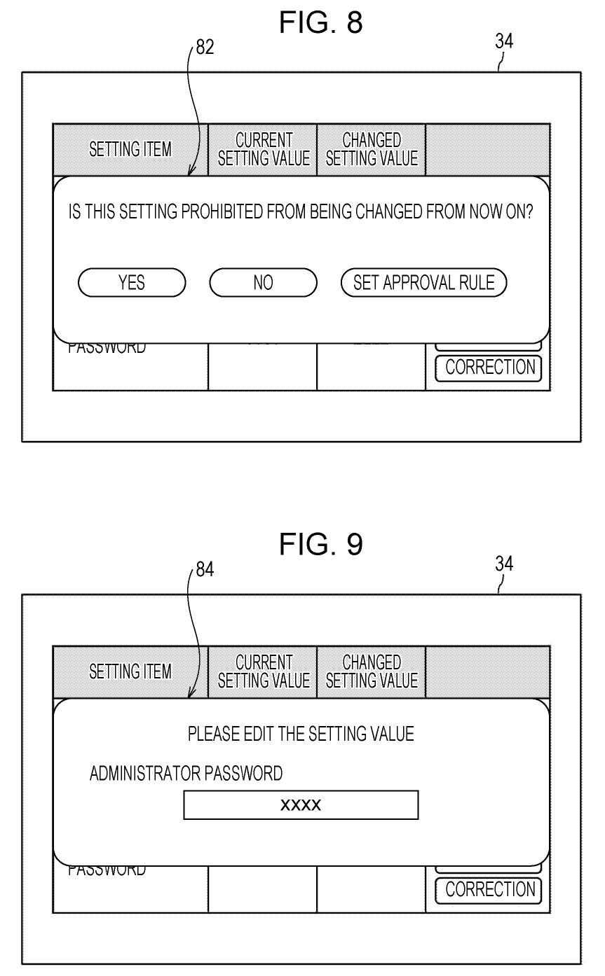

When the approver operates the disapproval button for a certain setting item on the approval screen (see FIG. 6), the approval processor 40 displays a setting prohibition confirmation window 82 as illustrated in FIG. 8 on the display 34. The setting prohibition confirmation window 82 includes a message saying "Is this setting prohibited from being changed from now on?", Yes button, No button, and an approval rule setting button.

The Yes button in the setting prohibition confirmation window 82 is a button for inputting direction to disapprove the changed setting as well as for inputting direction to change the approval rule 62. When the approver operates the Yes button, the approval processor 40 disapproves the changed setting value for the setting item, and the approval rule director 42 accepts, from the approver, an updated approval rule that defines the changed setting value for the setting item as the setting value impossible to be set.

The No button in the setting prohibition confirmation window 82 is simply a button for inputting direction to disapprove the changed setting. When the approver operates the No button, the approval processor 40 disapproves the changed setting value for the setting item. In this situation, the updated approval rule is not input.

The approval rule setting button in the setting prohibition confirmation window 82 will also be described.

When the approver operates the correction button for a certain setting item on the approval screen (see FIG. 6), the approval processor 40 displays a setting value change window 84 as illustrated in FIG. 9 on the display 34. The setting value change window 84 includes a message saying "Please edit the setting value" and an input field for setting value. In the setting value change window 84, the approver can change the changed setting value input by the dealer in step S16.

The approval rule setting button in the approval unnecessary confirmation window 80 (see FIG. 7) or the setting prohibition confirmation window 82 (see FIG. 8) is a button for inputting detailed updated approval rule related to the setting item. In particular, by operating the approval rule setting button, the approver can input an updated approval rule for the setting values other than the changed setting value input by the dealer.

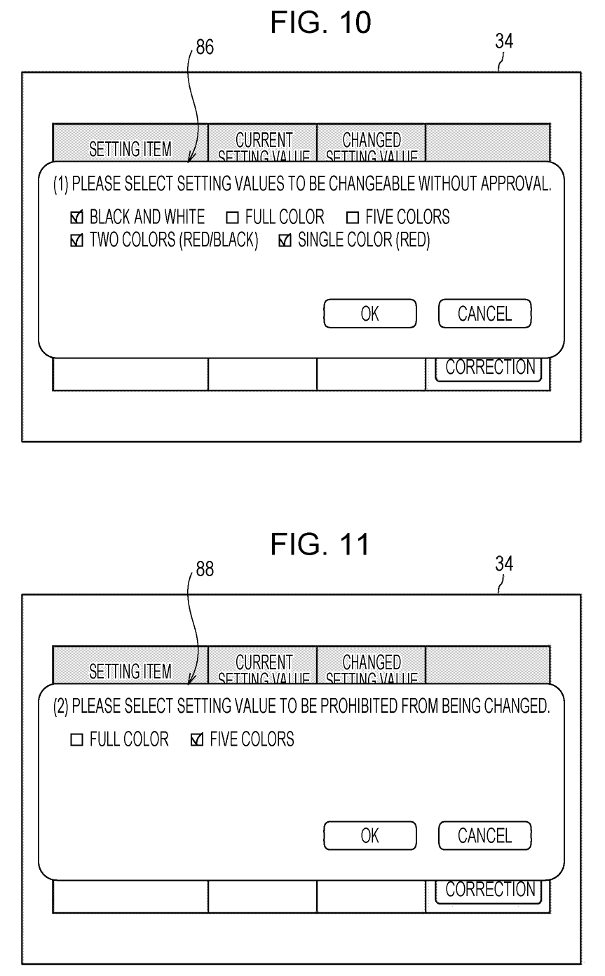

When the approver operates the approval rule setting button for a certain setting item (which is assumed to be "default color mode" here), the approval rule director 42 displays a first approval rule setting window 86 as illustrated in FIG. 10 on the display 34. The first approval rule setting window 86 includes a message saying "Please select setting values to be changeable without approval", the setting values "black and white", "full color" "five colors", "two colors (red/black)", and "single color (red)" which are settable for the setting item, a check box for each setting value, an OK button, and a cancel button.

In the first approval rule setting window 86, by checking a check box, the approver can select a setting value from the setting values for the setting item, the setting value being settable by the dealer without obtaining approval from the approver. When the approver selects a desirable setting value (may not select any setting value), and operates the OK button, the approval rule director 42 displays a second approval rule setting window 88 as illustrated in FIG. 11 on the display 34. The approver can cancel input of an updated approval rule by operating the cancel button.

The second approval rule setting window 88 includes: a message saying "Please select setting value to be prohibited from being changed"; the setting values not selected by the approver among the setting values settable for the setting item in the first approval rule setting window 86; a check box for each setting value; an OK button; and a cancel button.

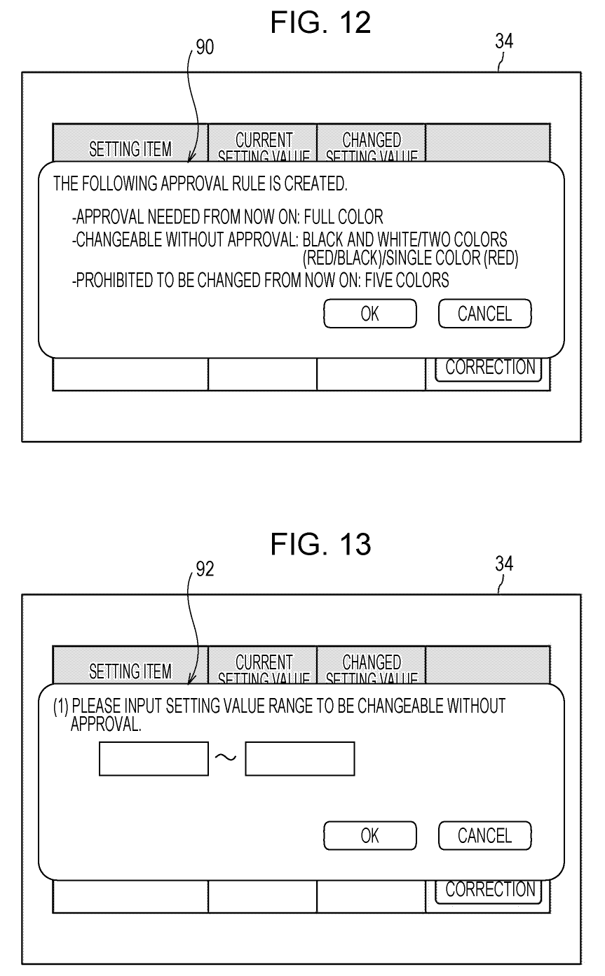

In the second approval rule setting window 88, by checking a check box, the approver can select a setting value from the setting values for the setting item, the setting value being impossible to be set by the dealer. When the approver selects a desirable setting value (may not select any setting value), and operates the OK button, the approval rule director 42 displays a third approval rule setting window 90 as illustrated in FIG. 12 on the display 34.

The third approval rule setting window 90 is a confirmation screen for the updated approval rule for the setting item, input by the approver in the first approval rule setting window 86 and the second approval rule setting window 88. The third approval rule setting window 90 includes: a message saying "The following approval rule is created"; the setting values settable (specifically, the setting values not selected in any of the first approval rule setting window 86 and the second approval rule setting window 88) by the dealer on the condition of obtaining approval from the approver; the setting values which are input in the first approval rule setting window 86 and settable by the dealer without obtaining approval from the approver; the setting values which are input in the second approval rule setting window 88 and impossible to be set by the dealer; an OK button; and a cancel button.

When the approver confirms the updated approval rule for the setting item and operates the OK button in the third approval rule setting window 90, the input of the approval rule is completed.

When the approver operates the approval rule setting button for a setting item having a numerical value as a setting value, the approval rule director 42 displays a fourth approval rule setting window 92 as illustrated in FIG. 13 on the display 34. The fourth approval rule setting window 92 includes a message saying "Please input a setting value range changeable without approval", an input field for the setting value range, an OK button, and a cancel button.

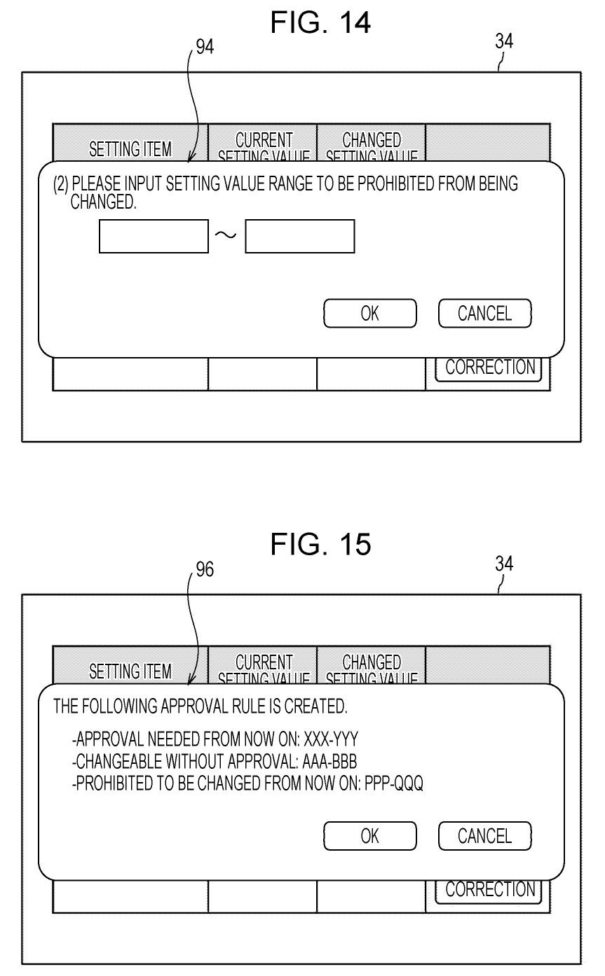

In the fourth approval rule setting window 92, the approver can input a setting value range (e.g., a minimum value and a maximum value) settable by the dealer without obtaining approval from the approver. When the approver inputs (may not input) a desirable setting value range, and operates the OK button, the approval rule director 42 displays a fifth approval rule setting window 94 as illustrated in FIG. 14 on the display 34.

The fifth approval rule setting window 94 includes a message saying "Please input setting value range to be prohibited from being changed", an input field for the setting value range, an OK button, and a cancel button.

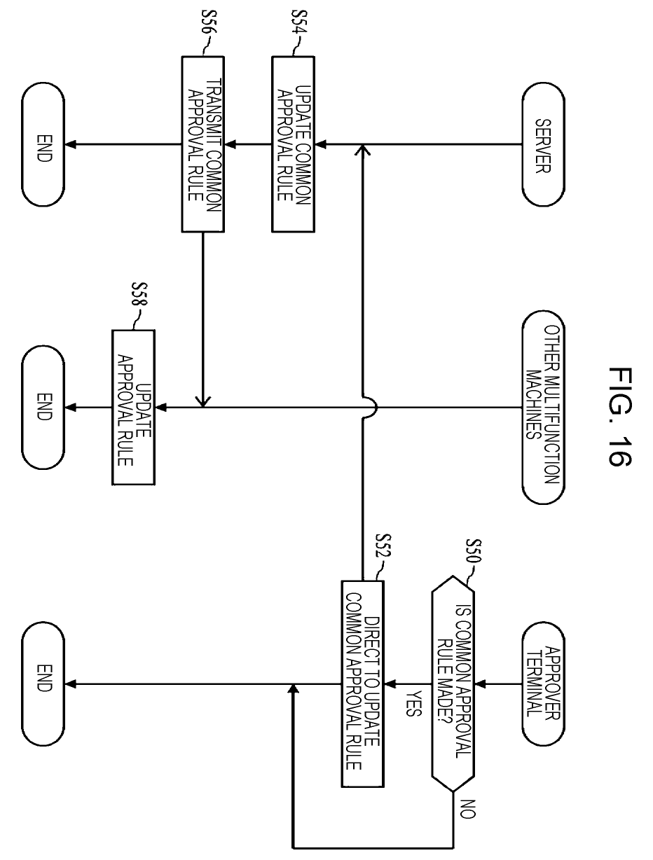

In the fifth approval rule setting window 94, the approver can input a setting value range (e.g., a minimum value and a maximum value) which is impossible to be set by the dealer. When the approver selects a desirable setting value (may not select any setting value), and operates the OK button, the approval rule director 42 displays a sixth approval rule setting window 96 as illustrated in FIG. 15 on the display 34.

The sixth approval rule setting window 96 is a confirmation screen for the approval rule for the setting item, input by the approver in the fourth approval rule setting window 92 and the fifth approval rule setting window 94. The sixth approval rule setting window 96 includes: a message saying "The following approval rule is created"; the setting value range (specifically, the value range which is among the ranges of available setting values for the setting item and has not been specified in any of the fourth approval rule setting window 92 and the setting window 94 for available setting values for the fifth approval rule setting item) settable by the dealer on the condition of obtaining approval from the approver; the setting value range which is input in the fourth approval rule setting window 92, and settable by the dealer without obtaining approval from the approver; the setting value range which is input in the fifth approval rule setting window 94 and impossible to be set by the dealer; an OK button; and a cancel button.

When the approver confirms the updated approval rule for the setting item and operates the OK button in the third approval rule setting window 90, the input of the approval rule is completed.

Returning to the flowchart of FIG. 5, in step S34, the approval processor 40 determines whether the changed setting according to the approval request received from multifunction machine 18 in step S28 has been approved by the approver. Specifically, the approval processor 40 determines whether the approval button has been operated on the approval screen (see FIG. 6). When the changed setting is approved, the approval processor 40 transmits information indicating that the changed setting has been approved by the approver to the multifunction machine 18, the flow proceeds to step S36. When the changed setting is not approved, step S36 is bypassed and the flow proceeds to step S38. In this situation, the approval processor 40 transmits information indicating that the changed setting has not been approved by the approver to the dealer terminal 12, and the processor of the dealer terminal 12 should notify the dealer that the changed setting has not been approved by the approver.

In step S36, the setting processor 70 of the multifunction machine 18 applies the changed setting according to the setting change direction received from the dealer terminal 12 in step S22. Thus, the device setting 60 is changed.

In step S38, the approval rule director 42 determines whether an updated approval rule has been accepted from the approver. Specifically, the approval rule director 42 determines whether the Yes button has been operated in the approval unnecessary confirmation window 80 (see FIG. 7) or the setting prohibition confirmation window 82 (see FIG. 8) and determines whether an updated approval rule has been input in the approval rule setting windows 86 to 96. When an updated approval rule is accepted, the approval rule director 42 transmits the updated approval rule accepted from the approver to the multifunction machine 18, and the flow proceeds to step S40. When an updated approval rule is not accepted, the process is completed.

In step S40, the approval rule setting part 66 of the multifunction machine 18 determines whether an updated approval rule has been received from the approver terminal 16. When an updated approval rule has been received, the flow proceeds to step S42, and when an updated approval rule has not been received, the process is completed.

In step S42, the approval rule setting part 66 stores the updated approval rule received in step S38 into the memory 58 as the approval rule 62. In other words, the approval rule 62 is changed.

As described above, in the exemplary embodiment, the approval rule 62 is set by the approval rule setting part 66, and when the direction to change the setting of the multifunction machine 18 is received from the dealer, the setting processor 70 determines whether the changed setting is applied, according to the approval rule 62. The approval rule 62 includes, for each setting item, the setting value settable by the dealer who is a set up person without obtaining approval from the approver, and the setting value impossible to be set by the dealer. Thus, the approval request processor 68 does not need to obtain approval from the approver each time direction to change the setting of the multifunction machine 18 is received from the dealer. Thus, as compared to when approval is obtained from the approver each time direction to change the setting of the multifunction machine 18 is received, the time and effort of at least one of the dealer or the approver can be reduced at the time of change of the setting value.

In the exemplary embodiment, the approval rule setting part 66 does not preset the approval rule 62 for a plurality of setting items of the multifunction machine 18 but sets the approval rule 62 for a setting item at the timing when direction to change the setting value for the setting item of the multifunction machine 18 is given. The multifunction machine 18 may have a large number of setting items, and presetting the approval rules 62 for a large number of setting items at one time may take considerable time and effort. In such a situation, it is possible to prevent significant time and effort from being taken by the approver at one time by setting the approval rule 62 only for the setting item related to the direction to change the setting from the dealer.

In the exemplary embodiment described above, when the approval rule setting system 10 includes a plurality of multifunction machines 18, the approval rule 62 varies with each multifunction machine 18; however, the approval rule 62 may be used in common between the plurality of multifunction machines 18. In other words, the approval rule setting part 66 may perform control to set the approval rule 62 set in one multifunction machine 18 as the approval rule 62 in other multifunction machines 18 according to the direction from the approver. In the present specification, the approval rule 62 set in common between the plurality of multifunction machines 18 is referred to as the "common approval rule".

The approver may select multifunction machines 18 for setting a common approval rule from the plurality of multifunction machines 18. In other words, the approval rule setting part 66 may perform control to set the approval rule 62 set in one multifunction machine 18 as the approval rule 62 in other multifunction machines 18 selected by the approver.

In the exemplary embodiment, the common approval rule used in common between the plurality of multifunction machines 18 is stored in the server 14, and is transmitted from the server 14 to each multifunction machine 18, thereby setting the common approval rule to each multifunction machine 18.

FIG. 16 is a flowchart illustrating the flow of a setting process for a common approval rule. Hereinafter, the flow of the setting process for a common approval rule will be described based on the flowchart. The process illustrated in the flowchart of FIG. 16 is performed followed by the setting process for the approval rule 62 illustrated in FIGS. 4 and 5.

In step S50, the approval rule director 42 of the approver terminal 16 determines according to the direction of the approver whether the updated approval rule input by the approver is set as a common approval rule. When the approver inputs direction to set a common approval rule, the flow proceeds to step S52, and when the approver inputs no direction to set a common approval rule, the process is completed.

In step S52, the approval rule director 42 transmits the updated approval rule input by the approver and direction to update the common approval rule to the server 14.

In step S54, the processor of the server 14 updates the common approval rule stored in the memory of the server 14 to the content of the received updated approval rule. If the common approval rule is not stored in the memory of the server 14, the updated approval rule received from the approver terminal 16 should be newly stored as the common approval rule.

In step S56, the processor of the server 14 transmits the common approval rule updated in step S54 to other multifunction machines 18 (other than the multifunction machine 18 for which the approval rule 62 has been updated in step S42 of FIG. 5).

In step S58, the approval rule setting part 66 of other multifunction machines 18 stores the received common approval rule in the memory 58 as the approval rule 62.

Although the exemplary embodiment according to the present disclosure been described above, the present disclosure is not limited to the above exemplary embodiment, and various modifications are possible in a range without departing from the gist of the present disclosure.

For example, in the above exemplary embodiment, the set up person who changes the setting of the multifunction machine 18 is the dealer, but the set up person is not necessarily the dealer. For example, the user of the multifunction machine 18 may be the set up person.

In the above exemplary embodiment, the setting target device for which setting is to be changed by the set up person is the multifunction machine 18; however, the setting target device may be a device other than the multifunction machine 18.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The present disclosure is also applicable to a program and a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(1) An information processing system comprising:

a processor configured to:

set an approval rule that, for a setting item having a plurality of available setting values and being related to a setting target device, defines a setting value settable by a set up person without obtaining approval from an approver, a setting value settable by the set up person on a condition of obtaining approval from the approver, and a setting value impossible to be set by the set up person according to direction from the approver; and

upon direction given by the set up person to change a setting value for the setting item, perform a setting process for the setting value for the setting item according to the approval rule.

(2) The information processing system according to (1),

wherein the processor is configured to set, for the setting item having a numerical value as a setting value, the approval rule that defines a numerical value range settable by a set up person without obtaining approval from an approver, a numerical value settable by the set up person on a condition of obtaining approval from the approver, and a numerical value impossible to be set by the set up person.

(3) The information processing system according to (1) or (2),

wherein the processor is configured to:

upon direction given by the set up person to change a setting value for the setting item, output a notification to prompt setting of the approval rule to the approver, and set the approval rule for the setting item according to direction from the approver in response to the notification.

(4) The information processing system according to (3),

wherein a plurality of setting target devices, each of which is the setting target device, are provided, and

the processor is configured to perform control to set the approval rule set in one of the setting target devices as an approval rule in the other setting target devices according to direction from the approver.

(5) The information processing system according to (4),

wherein the processor is configured to perform control to set the approval rule set in one of the setting target devices as an approval rule in the other setting target devices selected by the approver.

(6) The information processing system according to (3),

wherein the set up person is other than a user and an administrator of the setting target device, and

the processor is configured to receive direction to change a setting value for the setting item from a set up person terminal used by the set up person.

(7) A program causing a computer to execute a process for information processing, the process comprising:

setting an approval rule that, for a setting item having a plurality of available setting values and being related to a setting target device, defines a setting value settable by a set up person without obtaining approval from an approver, a setting value settable by the set up person on a condition of obtaining approval from the approver, and a setting value impossible to be set by the set up person according to direction from the approver; and

upon direction given by the set up person to change a setting value for the setting item, performing a setting process for the setting value for the setting item according to the approval rule.

What is claimed is:

1. An information processing system comprising:
a processor configured to:
set an approval rule that, for a setting item having a plurality of available setting values and being related to a setting target device, defines a setting value settable by a set up person without obtaining approval from an approver, a setting value settable by the set up person on a condition of obtaining approval from the approver, and a setting value impossible to be set by the set up person according to direction from the approver; and
upon direction given by the set up person to change a setting value for the setting item, perform a setting process for the setting value for the setting item according to the approval rule.

2. The information processing system according to claim 1,
wherein the processor is configured to set, for the setting item having a numerical value as a setting value, the approval rule that defines a numerical value range settable by a set up person without obtaining approval from an approver, a numerical value settable by the set up person on a condition of obtaining approval from the approver, and a numerical value impossible to be set by the set up person.

3. The information processing system according to claim 1,
wherein the processor is configured to:
upon direction given by the set up person to change a setting value for the setting item, output a notification to prompt setting of the approval rule to the approver, and set the approval rule for the setting item according to direction from the approver in response to the notification.

4. The information processing system according to claim 2,
wherein the processor is configured to:
upon direction given by the set up person to change a setting value for the setting item, output a notification to prompt setting of the approval rule to the approver, and set the approval rule for the setting item according to direction from the approver in response to the notification.

5. The information processing system according to claim 3,
wherein a plurality of setting target devices, each of which is the setting target device, are provided, and
the processor is configured to perform control to set the approval rule set in one of the setting target devices as an approval rule in the other setting target devices according to direction from the approver.

6. The information processing system according to claim 4,
wherein a plurality of setting target devices, each of which is the setting target device, are provided, and
the processor is configured to perform control to set the approval rule set in one of the setting target devices as an approval rule in the other setting target devices according to direction from the approver.

7. The information processing system according to claim 5,
wherein the processor is configured to perform control to set the approval rule set in one of the setting target devices as an approval rule in the other setting target devices selected by the approver.

8. The information processing system according to claim 6,
wherein the processor is configured to perform control to set the approval rule set in one of the setting target devices as an approval rule in the other setting target devices selected by the approver.

9. The information processing system according to claim 3,
wherein the set up person is other than a user and an administrator of the setting target device, and
the processor is configured to receive direction to change a setting value for the setting item from a set up person terminal used by the set up person.

10. The information processing system according to claim 4,
wherein the set up person is other than a user and an administrator of the setting target device, and
the processor is configured to receive direction to change a setting value for the setting item from a set up person terminal used by the set up person.

11. A non-transitory computer readable medium storing a program causing a computer to execute a process for information processing, the process comprising:
setting an approval rule that, for a setting item having a plurality of available setting values and being related to a setting target device, defines a setting value settable by a set up person without obtaining approval from an approver, a setting value settable by the set up person on a condition of obtaining approval from the approver, and a setting value impossible to be set by the set up person according to direction from the approver; and
upon direction given by the set up person to change a setting value for the setting item, performing a setting process for the setting value for the setting item according to the approval rule.

12. An information processing method comprising:
setting an approval rule that, for a setting item having a plurality of available setting values and being related to a setting target device, defines a setting value settable by a set up person without obtaining approval from an approver, a setting value settable by the set up person on a condition of obtaining approval from the approver, and a setting value impossible to be set by the set up person according to direction from the approver; and
upon direction given by the set up person to change a setting value for the setting item, performing a setting process for the setting value for the setting item according to the approval rule.
